(19) United States
(12) Patent Application Publication
(10) Pub. No.: US 2017/0339050 A1
(43) Pub. Date: Nov. 23, 2017

(54) A NETWORK ELEMENT FOR A DATA TRANSFER NETWORK

(71) Applicant: CORIANT OY, Espoo (FI)

(72) Inventors: Ville HALLIVUORI, Espoo (FI); Marko KULMALA, Espoo (FI); Antti POUTANEN, Espoo (FI)

(21) Appl. No.: 15/524,136

(22) PCT Filed: Jun. 8, 2015
(86) PCT No.: PCT/FI2015/050394

§ 371 Date: May 3, 2017

(30) Foreign Application Priority Data
Nov. 5, 2014 (FI) 20145966

(51) Int. Cl. H04L 12/725; H04L 12/715; H04L 12/727; H04L 12/707

(52) U.S. Cl. CPC H04L 45/302; H04L 45/24; H04L 45/04; H04L 45/121

(57) ABSTRACT

A network element includes a processing system for supporting inter-area data transfer paths which are Border Gateway Protocol load sharing data paths. The processing system maintains usage attributes expressing whether a given inter-area data transfer path is to be used for servicing a given traffic category. The processing system recognizes a traffic category of a data frame to be forwarded on the basis of for example the Quality-of-Service class of the data frame. Thereafter, the processing system selects one of the inter-area data transfer paths at least partly on the basis of the usage attributes and the recognized traffic category, and forwards the data frame to the selected inter-area data transfer path. Therefore, Border Gateway Protocol load sharing can be utilized for providing for example Quality-of-Service class differentiated traffic engineering.

### TECHNICAL FIELD

The disclosure relates generally to traffic engineering “TE” in data transfer networks. Furthermore, the disclosure relates to a method and to a computer program for enabling inter-area traffic engineering in a data transfer network.

### BACKGROUND

Typical data transfer protocols and network configuration protocols where traffic engineering “TE” is available are designed to operate within a single Interior Gateway Protocol “IGP” area of an Internet Protocol “IP” network. Examples of IGP protocols where the traffic engineering is available are the Open Shortest Path First protocol with traffic engineering “OSPF-TE”, the Intermediate System to Intermediate System protocol with traffic engineering, and the Route Information Protocol version 2 “RIPv2”. For example, in conjunction with the traditional non-seamless MultiProtocol Label Switching “MPLS”, each Label Switched Path “LSP” is within a single Autonomous System “AS” and, within this AS, Quality-of Service “QoS” class differentiated and/or service differentiated traffic engineering is available via Resource reservation protocol traffic engineered “RSVP-TE” tunnels. In this case, data frames representing for example different QoS-classes can be directed to different RSVP-TE tunnels each being suitable for the QoS-class related to that RSVP-TE tunnel. The QoS-class and/or service differentiated traffic engineering is needed for example in cases where data traffic comprises portions representing different traffic categories which have different requirements concerning for example end-to-end transfer delay variation, allowable frame loss rate, etc.

The situation is, however, more challenging when there is a need for QoS-class and/or service differentiated traffic engineering between areas of a data transfer network which are such that it is complicated or even impossible to arrange RSVP-TE tunnels through these areas. Areas of the kind mentioned above are for example IGP-areas of an IP-network and Autonomous Systems “AS” of an IP-network.

For example, in conjunction with the Seamless MPLS “S-MPLS” where LSPs can reach through many Autonomous Systems, only Border Gateway Protocol Labeled Unicast “BGP LU” paths are available between network elements belonging to different Autonomous Systems. Since the traditional way of using RSVP-TE tunnels enables traffic engineering to a next BGP next-hop but not further than that, it is usually not possible to achieve QoS-class and/or service differentiated traffic engineering between the above-mentioned network elements in the above-described traditional way. A challenge of the kind described above can be present also in a traditional MPLS network which is divided to areas so that it is complicated to arrange RSVP-TE tunnels through these areas. Therefore, there is a need for technologies for enabling QoS-class differentiated and/or service differentiated inter-area traffic engineering between areas of a data transfer network which are such that it is complicated or even impossible to arrange RSVP-TE tunnels through these areas.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new method for enabling inter-area traffic engineering in a data transfer network. A method according to the invention comprises:
supporting inter-area data transfer paths which are multipath load sharing data paths established with the Border Gateway Protocol “BGP”,
maintaining usage attributes expressing, for each of the inter-area data transfer paths and for each of pre-determined traffic categories, whether the inter-area data transfer path under consideration is to be used for servicing the traffic category under consideration,
recognizing a traffic category of a data frame to be forwarded,
selecting one of the inter-area data transfer paths at least partly on the basis of the usage attributes and the recognized traffic category of the data frame, and
forwarding the data frame to the selected one of the inter-area data transfer paths.

The above-mentioned pre-determined traffic categories have different requirements with respect to e.g. transfer delay variation so that the transfer delay variation allowed for data traffic representing a first one of the pre-determined traffic categories, i.e. a delay variation critical traffic category, is smaller than transfer delay variation allowed for data traffic representing a second one of the predetermined traffic categories.

The technical effect achieved with the above-defined method is that BGP load sharing multipath data paths can be utilized for enabling QoS-class and/or service differentiated traffic engineering between such areas of a data transfer network, e.g. Autonomous Systems “AS” of an Internet Protocol “IP” network, though which it is complicated or even impossible to arrange Resource reservation protocol traffic engineered “RSVP-TE” tunnels. For example, the load sharing between the inter-area data transfer paths can be controlled on the basis of e.g. QoS-classes of data frames of data traffic which is shared between the inter-area data transfer paths. Therefore, in this exemplifying and non-limiting case, the load sharing functionality is used for implementing QoS-class differentiated traffic engineering. Details of the BGP can be found from e.g. the following Request for Comments “RFC” documents of the Internet Engineering Task Force “IETF”: RFC1771 and RFC4271 a Border Gateway Protocol 4 “BGP-4”, and RFC3107 carrying label Information in BGP-4.

In accordance with the invention, there is provided also a new network element for a data transfer network. The network element can be, for example, an Internet Protocol “IP” router, a multiprotocol label switching “MPLS” switch, a packet optical switch, and/or an Ethernet switch. A network element according to the invention comprises a data transfer interface for transmitting data to the data transfer network and for receiving data from the data transfer network, and a processing system adapted to:
support inter-area data transfer paths which are multipath load sharing data paths established with the Border Gateway Protocol “BGP”,
maintain usage attributes expressing, for each of the inter-area data transfer paths and for each of pre-determined traffic categories, whether the inter-area data transfer path under consideration is to be used for servicing the traffic category under consideration,
recognize a traffic category of a data frame to be forwarded,
select one of the inter-area data transfer paths at least partly on the basis of the usage attributes and the recognized traffic category of the data frame, and
control the data transfer interface to forward the data frame to the selected one of the inter-area data transfer paths.

In accordance with the invention, there is provided also a new computer program for enabling inter-area traffic engineering in a data transfer network. A computer program according to the invention comprises computer executable instructions for controlling a programmable processing system of a network element of the data transfer network to:
support inter-area data transfer paths which are multipath load sharing data paths established with the Border Gateway Protocol “BGP”,
maintain usage attributes expressing, for each of the inter-area data transfer paths and for each of pre-determined traffic categories, whether the inter-area data transfer path under consideration is to be used for servicing the traffic category under consideration,
recognize a traffic category of a data frame to be forwarded,
select one of the inter-area data transfer paths at least partly on the basis of the usage attributes and the recognized traffic category of the data frame, and
control a data transfer interface of the network element to forward the data frame to the selected one of the inter-area data transfer paths.

In accordance with the invention, there is provided also a new computer program product. The computer program product comprises a non-volatile computer readable medium, e.g. a compact disc “CD”, encoded with a computer program according to the invention.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

The exemplifying and non-limiting embodiments of the invention and their advantages are explained in greater detail below with reference to the accompanying drawings, in which:

FIG. 1 shows a schematic illustration of an exemplifying data transfer network comprising at least one network element according to an exemplifying and non-limiting embodiment of the invention,

FIG. 2 shows a schematic illustration of a network element according to an exemplifying and non-limiting embodiment of the invention, and

FIG. 3 shows a flow chart of a method according to an exemplifying and non-limiting embodiment of the invention for enabling inter-area traffic engineering in a data transfer network.

### DESCRIPTION OF EXEMPLIFYING EMBODIMENTS

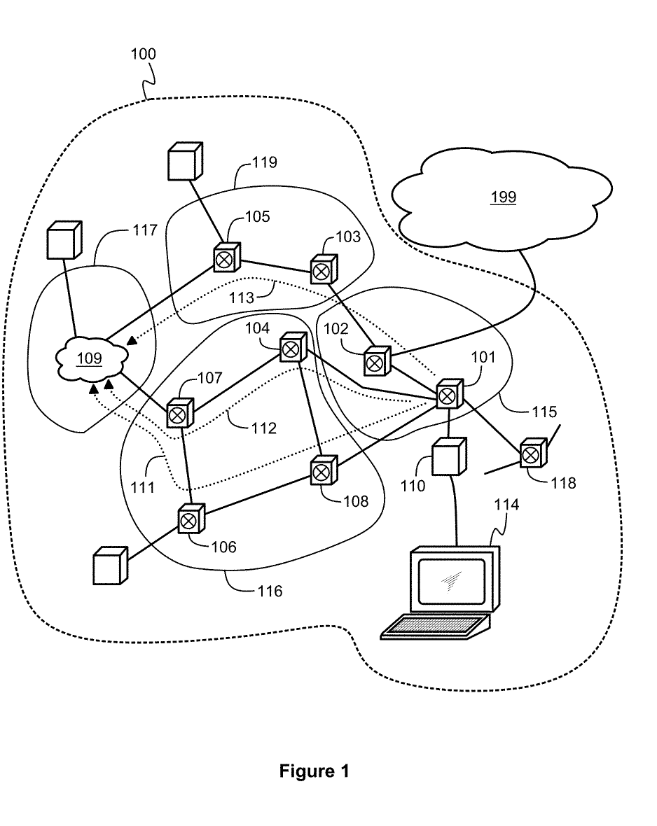

FIG. 1 shows a schematic illustration of an exemplifying data transfer network 100. The data transfer network comprises network elements 101, 102, 103, 104, 105, 106, 107, and 108. The network elements 101-108 are mutually interconnected with data transfer links as illustrated in FIG. 1. The network element 102 acts as a gateway to an external network 199 that can be e.g. the global Internet. Each of the network elements may be e.g. an Internet Protocol “IP” router, a multi-protocol label switching “MPLS” node, a packet optical switch, and/or an Ethernet switch. Each network element may consist of a single apparatus or a combination of a plurality of apparatuses. In this exemplifying case, the network elements 101 and 102 belong to area 115, the network elements 104, 106, 107, and 108 belong to an area 116, the network elements 103 and 105 belong to an area 119, and a sub-network 109 belongs to an area 117. The sub-network 109 can be a single network element or an entity comprising a plurality of interconnected network elements. The above-mentioned areas 115, 116, 117, and 119 of the data transfer network 100 can be for example Interior Gateway Protocol “IGP” areas. Each of the IGP-areas can be for example an IP-network Autonomous System “AS” or a part of an AS. The exemplifying data transfer network 100 further comprises a network element 118 which belong to an area other than the above-mentioned areas 115, 116, 117, and 119. Furthermore, the exemplifying data transfer network 100 may comprise other network elements and/or data transfer links that are not shown in FIG. 1.

Without limiting the generality and merely for illustrative purposes, we consider inter-area data transfer paths 111, 112, and 113 which are multipath load sharing data paths established with the Border Gateway Protocol “BGP”. In FIG. 1, the inter-area data transfer paths are illustrated with the aid of dashed line arrows. The data transfer path 111 extends from the network element 101 to the sub-network 109 via network elements 108, 106 and 107, the data transfer path 112 extends from the network element 101 to the sub-network 109 via network elements 104 and 107, and the data transfer path 113 extends from the network element 101 to the sub-network 109 via network elements 102, 103 and 105.

Without limiting the generality and merely for illustrative purposes, we consider the operation of the network element 101 from which there are the above-mentioned three different inter-area data transfer paths 111, 112, and 113 to the sub-network 109. In this exemplifying case, we assume that the network element 108 has advertised to the network element 101 that the network element 108 provides access to the sub-network 109, the network element 104 has advertised to the network element 101 that the network element 104 provides access to the sub-network 109, and the network element 102 has advertised to the network element 101 that the network element 102 provides access to the sub-network 109. Hence, the network element 101 is aware of that there are the three possible data transfer paths to a destination represented by the sub-network 109.

The network element 101 is adapted to support the above-mentioned inter-area data transfer paths 111-113 and to maintain usage attributes which express, for each of the inter-area data transfer paths 111-113 and for each of pre-determined traffic categories, whether the inter-area data transfer path under consideration is to be used for servicing the traffic category under consideration. The predetermined traffic categories have different requirements with respect to e.g. transfer delay variation so that the transfer delay variation allowed for data traffic representing a first one of the pre-determined traffic categories, i.e. a delay variation critical traffic category, is smaller than transfer delay variation allowed for data traffic representing a second one of the pre-determined traffic categories. The delay variation can be expressed with the aid of e.g. the standard deviation or the variance of the data transfer delay. The pre-determined traffic categories may represent for example different Quality-of-Service “QoS” classes and/or different services such as e.g. the Voice over Internet Protocol “VoIP” and the HyperText Transfer Protocol “HTTP”. The network element 101 recognizes a traffic category of a data frame to be forwarded to the sub-network 109. The recognized traffic category is one of the pre-determined traffic categories, and the traffic category of the data frame can be determined on the basis of the Quality-of-Service “QoS” class of the data frame and/or a service provided with data traffic including the data frame. The network element 101 selects one of the inter-area data transfer paths 111-113 on the basis of the above-mentioned usage attributes and the recognized traffic category of the data frame, and forwards the data frame to the selected one of the inter-area data transfer paths. It is also possible that, concerning one or more of the traffic categories, there is a group of two or more inter-area data transfer paths allocated for a single traffic category. In this exemplifying case, the standard BGP load sharing process can be used for selecting the inter-area data transfer path from the group of the inter-area data transfer paths after the group has been selected on the basis of the usage attributes and the recognized traffic category of a data frame to be forwarded. The BGP load sharing process can be based on for example a hash-function directed to the data frame, and the inter-area data transfer path can be selected from the above-mentioned group on the basis of the result of the hash-function. Therefore, in this exemplifying case, the inter-area data transfer path is selected on the basis of the usage attributes, the recognized traffic category of the data frame, and the result of the hash-function. It is also possible that instead of or in addition to the result of the hash-function some other information is used, in addition to the usage attributes and the recognized traffic category, in the selection of the inter-area data transfer path.

In an exemplifying and non-limiting case, the above-mentioned usage attributes are determined by policy configuration data. The network element 101 may receive the policy configuration data for example from a network management system “NMS”. In FIG. 1, the network management system is depicted with a network element 110 and the user interface 114. It is also possible that the policy configuration data is loaded to the network element locally e.g. by maintenance personnel. The policy data may comprise for example a list of traffic categories permitted to be serviced by each of the inter-area data transfer paths 111-113. Without limiting the generality and merely for illustrative purposes, we consider an exemplifying case where the policy configuration data indicates that only data frames belonging to the Expedited Forwarding “EF” QoS-class, i.e. EF data frames, are permitted to be serviced by the inter-area data transfer path 111, only data frames belonging to the Assured Forwarding “AF” QoS-class, i.e. AF data frames, are permitted to be serviced by the inter-area data transfer path 112, and only data frames belonging to the Best Effort “BE” QoS-class, i.e. BE data frames, are permitted to be serviced by the inter-area data transfer path 113. In this exemplifying case, the usage attributes express that the inter-area data transfer path 111 is to be used for the EF data frames, the inter-area data transfer path 112 is to be used for the AF data frames, and the inter-area data transfer path 113 is to be used for the BE data frames. In many cases the above-mentioned AF QoS-class comprises sub-classes AF1, AF2, AF3, and AF4 and there can be separate inter-area data transfer paths for each of the sub-classes or for pre-determined aggregates of the sub-classes. The above-mentioned QoS-classes EF and AF are defined, inter alia, in the following Request for Comments “RFC” documents of the Internet Engineering Task Force “IETF”: RFC 2597 Assured forwarding “AF” Per Hop Behavior “PHB” group, RFC 3246 Expedited forwarding “EF” PHB, and RFC 3247 Supplemental information for the new definition of the EF PHB. The above-mentioned BE QoS-class means that the data transfer network does not provide any guarantees that data is delivered or that a user is given a guaranteed quality of service level or a certain priority. Data traffic representing the BE QoS-class obtains best-effort service, meaning that it obtains unspecified variable bit rate and delivery time, depending on the current traffic load.

Advantageously, the network element 101 is allowed to advertise the reachability for the sub-network 109 to one or more other network elements only in a case where the usage attributes express that at least pre-determined ones of the pre-determined traffic categories are to be serviced with one or more of the data transfer paths 111-113, i.e. the data transfer paths comprise at least one data transfer path available to each of the predetermined ones of the traffic categories. For example, the network element 101 can be adapted to advertise the reachability for the sub-network 109 to the network element 118 only in a case where the data transfer paths 111-113 comprise at least one data transfer path available to each of the QoS-classes EF, AF, and BE. In the above-presented example case, where the data transfer path 111 is available to the EF QoS-class, the data transfer path 112 is available to the AF QoS-class, and the data transfer path 113 is available to the BE QoS-class, the network element 101 is allowed to advertise the reachability for the sub-network 109 to the network element 118. In another example case where none of the data transfer paths 111-113 is assumed to be available to e.g. the AF QoS-class, the network element 101 is not allowed to advertise the reachability for the sub-network 109 to the network element 118 because the standard BGP does not have a mechanism for informing the network element 118 that only EF and BE, but not AF data frames, are to be forwarded to the network element 101 and that the network element 101 may constitute an unwanted dead-end to the AF data frames.

In an exemplifying and non-limiting case, the network element 101 is adapted to compare properties of the inter-area data transfer paths 111-113 to category-specific requirements related to the pre-determined traffic categories so as to determine which one or ones of the inter-area data transfer paths is/are eligible for each of the predetermined traffic categories, e.g. for different QoS-classes and/or for different services. The category-specific requirements can be expressed for example by policy configuration data received at the network element. Information about the properties of the inter-area data transfer paths 111-113 can be obtained for example when establishing the inter-area data transfer paths 111-113. The network element 101 is adapted to determine the usage attributes on the basis of the results of the comparisons between the properties of the inter-area data transfer paths 111-113 and the category-specific requirements. Furthermore, the policy configuration data may contain additional requirements to be taken into account when determining the usage attributes. The properties of the inter-area data transfer paths 111-113 can be defined for example with: estimates of the data transfer delay variations caused by the inter-area data transfer paths, and/or the maximum available data transfer rates, bits/sec, through the inter-area data transfer paths, and/or the buffering capacities available on the inter-area data transfer paths, and/or one or more network technologies used for implementing the inter-area data transfer paths, and/or measured data frame loss rates of the inter-area data transfer paths, and/or measured bit error rates of the inter-area data transfer paths. Examples of network technologies are the Time Division Multiplexing “TDM” that is suitable for delay variation critical data traffic such as e.g. telephone services and Ethernet that is suitable for non-delay variation critical data traffic such as e.g. web browsing.

Without limiting the generality and merely for illustrative purposes, we consider an exemplifying and non-limiting situation where the above-mentioned policy configuration data comprises a first rule requiring that the standard deviation of the data transfer delay variation of EF data frames have to be less than d1 ms, a second rule requiring that the data transfer rate available for AF data frames has to be at least R1 bits/sec, a third rule requiring that AF data frames and BE data frames are not directed to a data transfer path used for the EF data frames, and a fourth rule requiring that the BE data frames are not directed to a data transfer path used for the AF data frames. In this exemplifying case, we assume that the standard deviation of the data transfer delay variation caused by the data transfer path 111 is less than the above-mentioned d1 ms and that the standard deviations of the data transfer delay variations of the data transfer paths 112 and 113 are both more than d1 ms. Furthermore, we assume that the maximum available data transfer rate through the data transfer path 111 is less than the above-mentioned R1 bits/sec, the maximum available data transfer rate through the data transfer path 112 is more than R1 bits/sec, and the maximum available data transfer rate through the data transfer path 113 is less than R1 bits/sec. In this exemplifying case, the usage attributes are set to express that the data transfer path 111 is to be used for the EF data frames, the data transfer path 112 is to be used for the AF data frames, and the data transfer path 113 is to be used for the BE data frames.

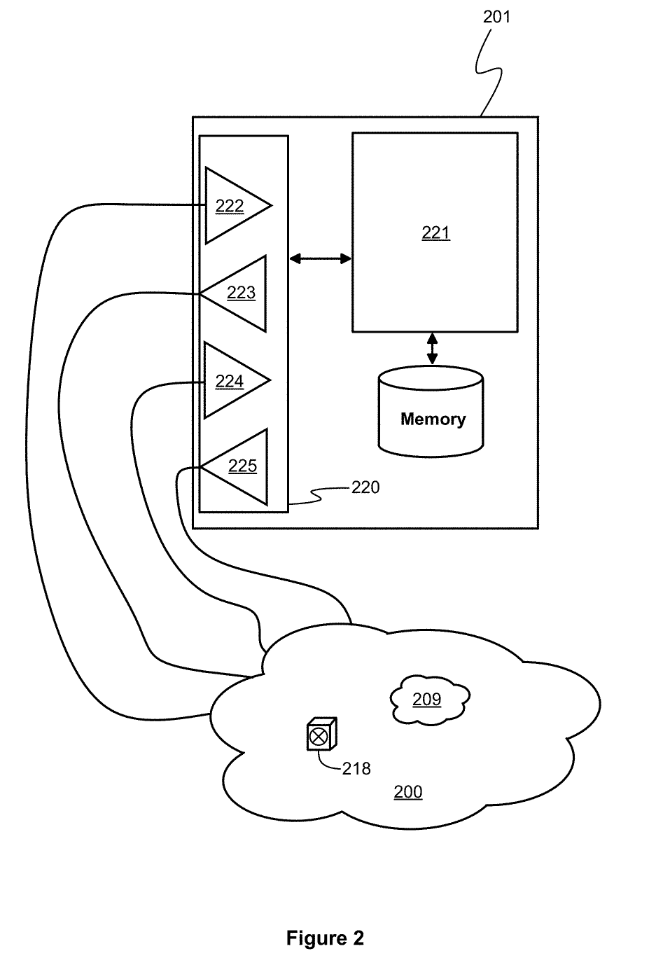

FIG. 2 shows a schematic illustration of a network element 201 according to an exemplifying and non-limiting embodiment of the invention. The network element can be, for example, an Internet Protocol “IP” router, a Multiprotocol label switching “MPLS” switch, a packet optical switch, and/or an Ethernet switch. The network element 201 comprises a data transfer interface 220 for receiving data and for transmitting data. The data transfer interface 220 comprises ingress ports 222 and 224 and egress ports 223 and 225 for connecting via data transfer links to other elements of a data transfer network. In FIG. 2, the elements of the data transfer network other than the network element 201 are depicted with a cloud 200. The network element comprises a processing system 221 adapted to support inter-area data transfer paths which are multipath load sharing data paths established with the Border Gateway Protocol “BGP” and which provide reachability for a destinction 209. Typically, the processing system 221 is adapted to run the Border Gateway Protocol “BGP” for establishing the inter-area data transfer paths. In principle, it is also possible that the protocol for establishing the inter-area data transfer paths is run in another network element which is adapted to configure the network element 201.

The processing system 221 is adapted to maintain usage attributes which express, for each of the inter-area data transfer paths and for each of pre-determined traffic categories, whether the inter-area data transfer path under consideration is to be used for servicing the traffic category under consideration. When there is a data frame to be delivered to the destination 209, the processing system 221 recognizes the traffic category of the data frame, selects one of the inter-area data transfer paths at least partly on the basis of the usage attributes and the recognized traffic category, and controls the data transfer interface 220 to forward the data frame to the selected one of the inter-area data transfer paths.

In a network element according to an exemplifying and non-limiting embodiment of the invention, the processing system 221 is adapted to control the data transfer interface 220 to advertise the reachability for the destination 209 to one or more other network elements 218 only in a case where the usage attributes express that at least pre-determined ones of the traffic categories are to be serviced using one or more of the inter-area data transfer paths.

In a network element according to an exemplifying and non-limiting embodiment of the invention, the processing system 221 is adapted to recognize the traffic category of the data frame to be forwarded on the basis of at least one of the following: i) a Quality-of-Service class of the data frame, ii) a service provided with data traffic including the data frame. In a network element according to an exemplifying and non-limiting embodiment of the invention, the traffic category of the data frame is the Quality-of-Service class of the data frame.

A network element according to an exemplifying and non-limiting embodiment of the invention is adapted to set the usage attributes in accordance with policy data received at the network element, e.g. from the network management system “NMS” of the data transfer network. The policy data may comprise for example a list of traffic categories permitted to be serviced by each of the inter-area data transfer paths. In this exemplifying case, the network element is adapted to set the usage attributes to correspond to the above-mentioned list.

A network element according to another exemplifying and non-limiting embodiment of the invention is adapted to set the usage attributes in accordance with: policy data received at the network element, properties of the inter-area data transfer paths, and category-specific requirements related to the pre-determined traffic categories. The category-specific requirements can be e.g. requirements related to different Quality-of-Service “QoS” classes and/or to different services. In this exemplifying case, the processing system 221 is adapted to compare the properties of the inter-area data transfer paths to the category-specific requirements so as to determine which one or ones of the inter-area data transfer paths is/are eligible for each of the predetermined traffic categories. The properties of the inter-area data transfer paths can be defined for example with: a) estimates of transfer delay variations caused by the inter-area data transfer paths, b) maximum available data transfer rates through the inter-area data transfer paths, c) buffering capacities available on the inter-area data transfer paths, d) one or more network technologies used for implementing the inter-area data transfer paths, e) data frame loss rates of the inter-area data transfer paths, and/or f) bit error rates of the inter-area data transfer paths.

The processing system 221 of the network element 201 can be implemented with one or more processor circuits, each of which can be a programmable processor circuit provided with appropriate software, a dedicated hardware processor such as, for example, an application specific integrated circuit “ASIC”, or a configurable hardware processor such as, for example, a field programmable gate array “FPGA”.

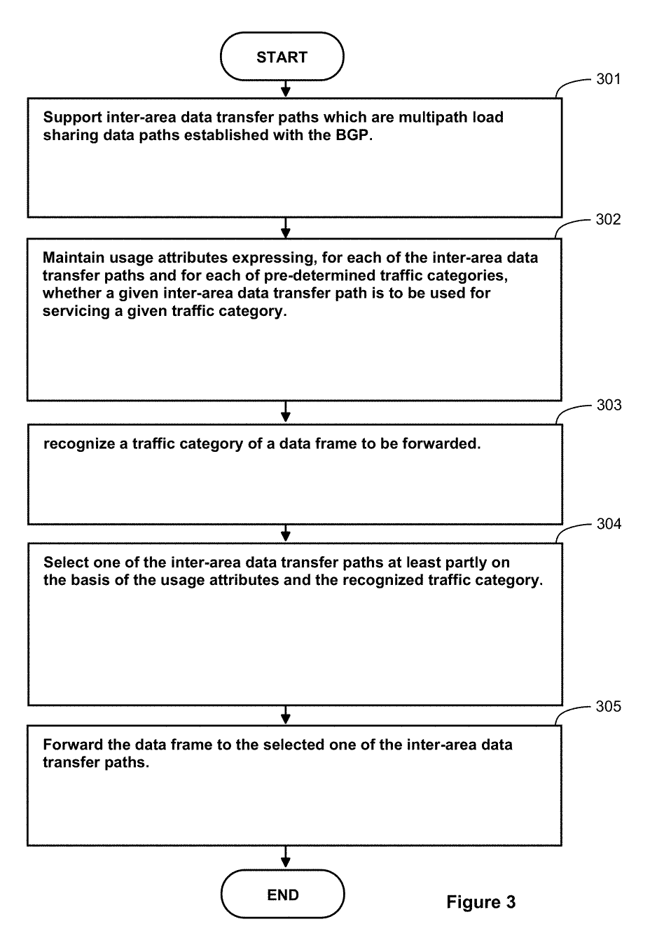

FIG. 3 shows a flow chart of a method according to an exemplifying and non-limiting embodiment of the invention for enabling inter-area traffic engineering in a data transfer network. The method comprises the following actions:
action 301: supporting inter-area data transfer paths which are multipath load sharing data paths established with the Border Gateway Protocol “BGP”,
action 302: maintaining usage attributes expressing, for each of the inter-area data transfer paths and for each of pre-determined traffic categories, whether the inter-area data transfer path under consideration is to be used for servicing the traffic category under consideration,
action 303: recognizing a traffic category of a data frame to be forwarded,
action 304: selecting one of the inter-area data transfer paths at least partly on the basis of the usage attributes and the recognized traffic category of the data frame, and
action 305: forwarding the data frame to the selected one of the inter-area data transfer paths.

A method according to an exemplifying and non-limiting embodiment of the invention comprises advertising, to one or more other network elements, reachability for a destination reachable via the inter-area data transfer paths only in a case where the usage attributes express that at least pre-determined ones of the traffic categories are to be serviced using one or more of the inter-area data transfer paths.

A method according to an exemplifying and non-limiting embodiment of the invention comprises recognizing the traffic category of the data frame on the basis of at least one of the following: i) a Quality-of-Service “QoS” class of the data frame, ii) a service provided with data traffic including the data frame.

In a method according to an exemplifying and non-limiting embodiment of the invention, the traffic category of the data frame is the Quality-of-Service class of the data frame.

A method according to an exemplifying and non-limiting embodiment of the invention comprises running the Border Gateway Protocol “BGP” in order to establish the inter-area data transfer paths.

A method according to an exemplifying and non-limiting embodiment of the invention comprises setting the usage attributes at least partly in accordance with policy data received from the data transfer network, e.g. from the network management system “NMS” of the data transfer network.

The policy data may comprise for example a list of traffic categories permitted to be serviced by each of the inter-area data transfer paths. In this exemplifying case, the method comprises setting the usage attributes to correspond to the above-mentioned list.

In a method according to another exemplifying and non-limiting embodiment of the invention, the usage attributes are set in accordance with: policy data received from the data transfer network, properties of the inter-area data transfer paths, and category-specific requirements related to the pre-determined traffic categories. The category-specific requirements can be e.g. requirements related to different Quality-of-Service “QoS” classes and/or to different services. In this exemplifying case, the method comprises comparing the properties of the inter-area data transfer paths to the category-specific requirements so as to determine which one or ones of the inter-area data transfer paths is/are eligible for each of the predetermined traffic categories. The properties of the inter-area data transfer paths can be defined for example with: a) estimates of transfer delay variations caused by the inter-area data transfer paths, b) maximum available data transfer rates through the inter-area data transfer paths, c) buffering capacities available on the inter-area data transfer paths, d) one or more network technologies used for implementing the inter-area data transfer paths, e) data frame loss rates of the inter-area data transfer paths, and/or f) bit error rates of the inter-area data transfer paths.

A computer program according to an exemplifying and non-limiting embodiment of the invention comprises computer executable instructions for controlling a programmable processing system to carry out actions related to a method according to any of the above-described exemplifying embodiments of the invention.

A computer program according to an exemplifying and non-limiting embodiment of the invention comprises software modules for enabling inter-area traffic in a data transfer network. The software modules comprise computer executable instructions for controlling a programmable processing system of a network element of the data transfer network to:
support inter-area data transfer paths which are multipath load sharing data paths established with the Border Gateway Protocol “BGP”,
maintain usage attributes expressing, for each of the inter-area data transfer paths and for each of pre-determined traffic categories, whether the inter-area data transfer path under consideration is to be used for servicing the traffic category under consideration,
recognize a traffic category of a data frame to be forwarded,
select one of the inter-area data transfer paths at least partly on the basis of the usage attributes and the recognized traffic category of the data frame, and
control a data transfer interface of the network element to forward the data frame to the selected one of the inter-area data transfer paths.

A computer program according to an exemplifying and non-limiting embodiment of the invention further comprises software modules for controlling the programmable processing system to control the data transfer interface to advertise, to one or more other network elements, reachability for a destination reachable via the inter-area data transfer paths only in a case where the usage attributes express that at least pre-determined ones of the traffic categories are to be serviced using one or more of the inter-area data transfer paths.

The software modules can be e.g. subroutines or functions implemented with a suitable programming language and with a compiler suitable for the programming language and for the programmable processing system under consideration. It is worth noting that also a source code corresponding to a suitable programming language represents the computer executable software modules because the source code contains the information needed for controlling the programmable processing system to carry out the above-presented actions and compiling changes only the format of the information. Furthermore, it is also possible that the programmable processing system is provided with an interpreter so that a source code implemented with a suitable programming language does not need to be compiled prior to running.

A computer program product according to an exemplifying embodiment of the invention comprises a computer readable medium, e.g. a compact disc “CD”, encoded with a computer program according to an exemplifying embodiment of invention.

A signal according to an exemplifying embodiment of the invention is encoded to carry information defining a computer program according to an exemplifying embodiment of invention.

The specific examples provided in the description given above should not be construed as limiting the scope and/or the applicability of the appended claims.

1-22. (canceled)

23. A network element for a data transfer network, the network element comprising a data transfer interface for receiving data from the data transfer network and for transmitting data to the data transfer network, and a processing system adapted to:
support inter-area data transfer paths which are multipath load sharing data paths established with the Border Gateway Protocol, and
recognize a traffic category of a data frame to be forwarded,
wherein the recognized traffic category of the data frame is one of pre-determined traffic categories such that transfer delay variation allowed for data traffic representing a first one of the pre-determined traffic categories is smaller than transfer delay variation allowed for data traffic representing a second one of the pre-determined traffic categories, wherein the processing system is further adapted to:
maintain usage attributes expressing, for each of the inter-area data transfer paths and for each of the predetermined traffic categories, whether the inter-area data transfer path under consideration is to be used for servicing the traffic category under consideration,
select one of the inter-area data transfer paths at least partly on the basis of the usage attributes and the recognized traffic category of the data frame, and
control the data transfer interface to forward the data frame to the selected one of the inter-area data transfer paths.

24. A network element according to claim 23, wherein the processing system is adapted to control the data transfer interface to advertise, to one or more other network elements, reachability for a destination reachable via the inter-area data transfer paths only in a case where the usage attributes express that at least pre-determined ones of the traffic categories are to be serviced using one or more of the inter-area data transfer paths.

25. A network element according to claim 23, wherein the processing system is adapted to recognize the traffic category of the data frame on the basis of at least one of the following: i) a Quality-of-Service class of the data frame, ii) a service provided with data traffic including the data frame.

26. A network element according to claim 25, wherein the traffic category of the data frame is the Quality-of-Service class of the data frame.

27. A network element according to claim 23, wherein the network element is adapted to run the Border Gateway Protocol so as to establish the inter-area data transfer paths.

28. A network element according to claim 23, wherein the network element is adapted to set the usage attributes at least partly in accordance with policy data received from the data transfer network.

29. A network element according to claim 28, wherein the policy data comprises a list of traffic categories permitted to be serviced by each of the inter-area data transfer paths, and the network element is adapted to set the usage attributes to correspond to the list.

30. A network element according to claim 23, wherein the processing system is adapted to compare properties of the inter-area data transfer paths to category-specific requirements related to the pre-determined traffic categories so as to determine which ones of the inter-area data transfer paths are eligible for each of the predetermined traffic categories.

31. A network element according to claim 30, wherein the properties of the inter-area data transfer paths are defined with one or more of the following: a) estimates of transfer delay variations caused by the inter-area data transfer paths, b) maximum available data transfer rates through the inter-area data transfer paths, c) buffering capacities available on the inter-area data transfer paths, d) one or more network technologies used for implementing the inter-area data transfer paths, e) data frame loss rates of the inter-area data transfer paths, f) bit error rates of the inter-area data transfer paths.

32. A network element according to claim 23, wherein the network element is at least one of the following: an Internet Protocol IP router, a MultiProtocol Label Switching MPLS switch, a packet optical switch, an Ethernet switch.

33. A method comprising:
supporting inter-area data transfer paths which are multipath load sharing data paths established with the Border Gateway Protocol, and
recognizing a traffic category of a data frame to be forwarded,
wherein the recognized traffic category of the data frame is one of pre-determined traffic categories such that transfer delay variation allowed for data traffic representing a first one of the pre-determined traffic categories is smaller than transfer delay variation allowed for data traffic representing a second one of the pre-determined traffic categories, wherein the method further comprises:
maintaining usage attributes expressing, for each of the inter-area data transfer paths and for each of the predetermined traffic categories, whether the inter-area data transfer path under consideration is to be used for servicing the traffic category under consideration,
selecting one of the inter-area data transfer paths at least partly on the basis of the usage attributes and the recognized traffic category of the data frame, and
forwarding the data frame to the selected one of the inter-area data transfer paths.

34. A method according to claim 33, wherein the method comprises advertising, to one or more other network elements, reachability for a destination reachable via the inter-area data transfer paths only in a case where the usage attributes express that at least pre-determined ones of the traffic categories are to be serviced using one or more of the inter-area data transfer paths.

35. A method according to claim 33, wherein the method comprises recognizing the traffic category of the data frame on the basis of at least one of the following: i) a Quality-of-Service class of the data frame, ii) a service provided with data traffic including the data frame.

36. A method according to claim 35, wherein the traffic category of the data frame is the Quality-of-Service class of the data frame.

37. A method according to claim 33, wherein the method comprises running the Border Gateway Protocol so as to establish the inter-area data transfer paths.

38. A method according to claim 33, wherein the method comprises setting the usage attributes at least partly in accordance with policy data received from a data transfer network.

39. A method according to claim 38, wherein the policy data comprises a list of traffic categories permitted to be serviced by each of the inter-area data transfer paths, and the method comprises setting the usage attributes to correspond to the list.

40. A method according to claim 33, wherein the method comprises comparing properties of the inter-area data transfer paths to category-specific requirements related to the predetermined traffic categories so as to determine the usage attributes so as to determine which ones of the inter-area data transfer paths are eligible for each of the predetermined traffic categories.

41. A method according to claim 40, wherein the properties of the inter-area data transfer paths are defined with one or more of the following: a) estimates of transfer delay variations caused by the inter-area data transfer paths, b) maximum available data transfer rates through the inter-area data transfer paths, c) buffering capacities available on the inter-area data transfer paths, d) one or more network technologies used for implementing the inter-area data transfer paths, e) data frame loss rates of the inter-area data transfer paths, f) bit error rates of the inter-area data transfer paths.

42. A non-transitory computer readable medium encoded with a computer program comprising computer executable instructions for controlling a programmable processing system of a network element of a data transfer network to:
support inter-area data transfer paths which are multipath load sharing data paths established with the Border Gateway Protocol, and
recognize a traffic category of a data frame to be forwarded,
wherein the recognized traffic category of the data frame is one of pre-determined traffic categories such that transfer delay variation allowed for data traffic representing a first one of the pre-determined traffic categories is smaller than transfer delay variation allowed for data traffic representing a second one of the pre-determined traffic categories, wherein the computer program further comprises computer executable instructions for controlling the programmable processing system to:
maintain usage attributes expressing, for each of the inter-area data transfer paths and for each of the predetermined traffic categories, whether the inter-area data transfer path under consideration is to be used for servicing the traffic category under consideration,
select one of the inter-area data transfer paths at least partly on the basis of the usage attributes and the recognized traffic category of the data frame, and
control a data transfer interface of the network element to forward the data frame to the selected one of the inter-area data transfer paths.

43. A non-transitory computer readable medium according to claim 42, wherein the computer program further comprises computer executable instructions for controlling the programmable processing system to control the data transfer interface to advertise, to one or more other network elements, reachability for a destination reachable via the inter-area data transfer paths only in a case where the usage attributes express that at least pre-determined ones of the traffic categories are to be serviced using one or more of the inter-area data transfer paths.

44. A network element according to claim 24, wherein the processing system is adapted to recognize the traffic category of the data frame on the basis of at least one of the following: i) a Quality-of-Service class of the data frame, ii) a service provided with data traffic including the data frame.

45. A method according to claim 34, wherein the method comprises recognizing the traffic category of the data frame on the basis of at least one of the following: i) a Quality-of-Service class of the data frame, ii) a service provided with data traffic including the data frame.
